(19) United States
(12) Patent Application Publication
(10) Pub. No.: US 2012/0311829 A1
(43) Pub. Date: Dec. 13, 2012

(54) REMOVABLE FASTENER CLIP

(76) Inventors: Daniel James Dickinson, Lake Zurich, IL (US); Shawn Michael Willis, Waterford, MI (US)

(21) Appl. No.: 13/159,408

(22) Filed: Jun. 13, 2011

(51) Int. Cl. F16B 2/20; F16B 45/00

(52) U.S. Cl. 24/458; 24/455

(57) ABSTRACT

A fastener clip comprises a prong clip that is operable to engage a carrier. The prong clip has a prong base on one end and a prong with a hook, at the other end of the prong clip. The carrier comprises a pair of laterally offset side wings extending from the sides of the carrier operable to fasten to a slot in a structure like a vehicle chassis. A pair of laterally offset arms extend from the carrier create a gap to form a hook receiver. The hook receiver is operable to engage the hook such that a service tool may operably disengage the hook from the hook receiver on a side of the slot that is opposite the base.

### RELATED APPLICATIONS

This is a continuation in part application claiming priority from an application entitled “CONTINUOUSLY ADAPTIVE FASTENER CLIP” having: a docket number P054, a Ser. No. 121/464,867, and a filing date of Aug. 1, 2009, which is a continuation in part of an application also entitled “CONTINUOUSLY ADAPTIVE FASTENER CLIP” having a docket number P053, a Ser. No. 11/870,412, and a filing date of Oct. 10, 2007, which is a continuation in part of an application entitled “Multicontact Adaptive Fastener Clip” having a docket number P042 (04.0002), a Ser. No. 11/277,107, and a filing date of Mar. 21, 2006, which is a continuation in part of U.S. Pat. No. 7,178,850 entitled “Tethered fastener apparatus and method” having a docket number P041 (04.001) filed on Feb. 9, 2005, the entire disclosures of which are incorporated herein by reference in their entirety.

### FIELD OF THE INVENTION

The disclosure relates generally to devices for fastening objects, and more particularly to a fastener clip for insertion into an engagement structure, such as a vehicle chassis, a hollow substrate, a wall, roof, a plate or any suitable object.

### BACKGROUND OF THE INVENTION

A number of devices and fasteners are currently available for fastening panels, such as body panels and automobile interior trim piece panels to the chassis of a vehicle. For example, weld nuts are known to fasten a roof rack to the roof of the vehicle. As used herein, a body panel refers to, for example, any interior or exterior body panel on a vehicle, a plastic interior trim piece, headliner or any interior trim piece. Additionally, the panel may be any suitable exterior body panel, such as a roof, fender, bumper, quarter panel or door panel. The chassis of the vehicle may include any substrate, plate, body panel, structural framework, chassis component or subcomponent, roof structure, wall or any suitable object.

Body panels are commonly mounted to a vehicle roof by a mounting bracket or carrier. Such carriers are secured to the roof of the vehicle by fastening screws, snap-in fasteners or bayonet-type fasteners. However, these conventional fasteners typically do not align properly with the roof mounting slots making assembly difficult, expensive and unreliable. Also, when these fasteners are installed during final assembly of the vehicle, final assembly is more time consuming and expensive.

Fastener clips, such as metal spring fasteners, are known for attaching body panels to an automobile chassis. For example, fastener clips are known having a base plate and four stepped arms extending from the base plate. Each stepped arm includes four incremental steps (stair-steps) suitable for engaging a slot in a vehicle chassis with one of the steps on each arm. The incremental steps allow for engagement, however, in only one of the four discrete step positions rather than over a continuous range of engagement positions. Further, each step has a relatively large rise and run so that, once inserted, movement of the fastener clip within the range of a step size may occur, resulting in wear and/or the generation of noise, including buzzing and rattling as a result of vibrations occurring within the vehicle. Also, the steps typically cut onto each arm during manufacture and also require twisting of each wing on the fastener clip in order to engage the slot in the vehicle chassis. As a result, only an edge or a portion of an edge of each of the steps engages the hole in the vehicle slot.

If the sheet metal varies in thickness or if tolerances in production of the slot in the vehicle chassis or in the trim-piece exist, for example, then engagement of one portion of the hole in the chassis with one of the arms may not provide suitable frictional engagement or otherwise result in movement. Further, less than all four of the arms will make engagement with the slot of the vehicle chassis. Twisting of the body panel will be likely more prevalent because less than four contact points are actually made with the slot of the vehicle chassis. As a result, wear, squeaks, rattles, buzzing, corrosion and loss of elasticity and loss of sealing may result, especially after years of vehicle operation and exposure to vibration and other environmental conditions.

These body panels typically are required to attach to the chassis of an automobile with a relatively low level of insertion force while providing a high level of extraction force suitable to maintain attachment of the panel to the chassis. However, these conventional fastener devices instead provide approximately relatively equal levels of insertion and extraction force. Further, conventional fasteners typically do not adequately secure the panel to the vehicle chassis having materials such as sheet metal with different curvature or thicknesses throughout. Also, conventional fasteners are not suitable under a variety of environmental conditions, such as in the presence of vibration at various levels of amplitude, frequency and occurrence. For example, the fastener device should prevent or minimize the amount of buzzing, rattling or any other type of noise that may cause attention to the occupants of the vehicle or otherwise weaken the attachment. Conventional fasteners do not adequately accommodate various levels of production tolerances, such as various dimensions amongst, for example, the body panels as well as the vehicle chassis components. Thus, conventional fastener devices typically do not adequately fasten to a range of sheet metal thicknesses and do not adequately minimize or eliminate buzzing and rattling and do not sufficiently accommodate variations in production tolerances in a cost efficient manner.

### BRIEF DESCRIPTION OF THE DRAWINGS

FIG. 1 is an exploded view of a fastener clip and assembly according to one embodiment;

FIG. 2 is a perspective view of the fastener clip and assembly according to one embodiment;

FIG. 3 is a top view of the fastener clip and assembly according to another embodiment;

FIG. 4 is a side view of the fastener clip and assembly according to another embodiment;

FIG. 5 is a side view of the fastener clip and assembly rotated 90 degrees;

FIG. 6 is a top perspective view of a prong clip according to one embodiment;

FIG. 7 is a side view of the prong clip shown in FIG. 6;

FIG. 8 is a bottom perspective view of the prong clip according to one embodiment;

FIG. 9 is a top view of the prong clip;

FIG. 10 is a bottom view of a carrier according to one embodiment;

FIG. 11 is a top view of the carrier according to one embodiment;

FIG. 12 is a side view of the carrier;

FIG. 13 is a side view of the carrier as shown in FIG. 12 rotated 90 degrees in accordance with an exemplary embodiment;

FIG. 14 is a top perspective view of the carrier according to one embodiment; and

FIG. 15 is a bottom perspective view of a carrier according to one embodiment.

### DETAILED DESCRIPTION OF THE PREFERRED EMBODIMENTS

A fastener clip comprises a prong clip that is operable to engage a carrier. The prong clip has a prong base on one end and a prong with a hook, at the other end of the prong clip. The carrier comprises a pair of laterally offset side wings extending from the sides of the carrier operable to fasten to a slot in a structure like a vehicle chassis. A pair of laterally offset arms extend from the carrier create a gap to form a hook receiver. The hook receiver is operable to engage the hook such that a service tool may operably disengage the hook from the hook receiver on a side of the slot that is opposite the base.

The prong clip thus attaches to the carrier via the prong with the hook and the carrier attaches to the chassis slot via the wings. The wings have an engagement region to fasten the fastener clip to a slot on a support structure such as a vehicle. The engagement regions may include a ledge and/or a depressed portion operable to adapt to variations or movement of a slot.

Among other advantages, the carrier is readily removable from the chassis slot and the prong clip is readily removable from the carrier. The carrier base comprises at least one channel formed into the carrier base to guide the service tool to disengage the hook from the hook receiver on a side of the slot that is opposite the base (for example the inside of the chassis).

The carrier properly aligns the prong clip for attachment into the chassis slot. A body panel, such a roof rack, may be attached to the prong clip as an assembly and shipped for final assembly in a vehicle. According to one embodiment, a roof rack/fastener clip assembly may be easily fastened to a slot and then attached to the vehicle roof, without the need for screws, nuts or weld nuts. During final assembly, the entire body panel, such as the roof rack assembly may simply be pushed in. The fastener clips are properly aligned and stabilized in the roof rack assembly for a correct fit and proper installation. The fastener clip allows the body panel to be aligned properly for assembly with a relatively low level of insertion force. The fastener clip provides a very high level of extraction force suitable for a roof rack.

The fastener clip is suitable for attachment of a body panel, such as an interior or exterior body panel with the vehicle chassis. The fastener clip is also suitable for use in heavy duty applications such as roof rack, panel mounts and pull-handle fasteners. The prong and wings have an engagement region, size, such as a width, length, thickness and pivot point to provide very high extraction force levels while the insertion force level is relatively low.

Further, the same fastener clip may be used with different sheet metal thicknesses and curvatures. For example, a vehicle may have different sheet metal thicknesses at various parts of the vehicle. The range of slot thicknesses varies continuously from a minimum thickness to a maximum thickness. The fastener clip is operative for insertion into the slot defined in a first engagement structure, such as a vehicle chassis. The fastener clip may adapt automatically to different sheet metal thicknesses and curvatures. Therefore, the same fastener clip may be used throughout the vehicle thus reducing or eliminating the need for specific fastener clips for specific slot thicknesses.

According to one embodiment, each wing independently engages the slot of the vehicle chassis in a continuous rather than discrete manner. Further, each wing adapts to changes, such as chassis flexing and vibrations of a wide range of amplitudes and frequencies, and other conditions.

Among other advantages, the simple alignment and relatively low level of insertion force is particularly advantageous for assembly line operators who repetitively insert body panels onto the vehicle chassis. The easy alignment and relatively low level of insertion force required for inserting the body panel into the vehicle chassis may result in fewer injuries to the assembly workers, including injuries related to repetitive stress syndrome. By eliminating conventional screws for fastening to the roof, assembly of the roof rack to the roof with the fastener clip significantly reduces assembly and servicing time and cost. Further, by eliminating multiple fasteners for different sheet metal thicknesses, confusion during assembly is eliminated reduced since the same type fastener may be used for all slots. Thus, an assembly worker need not worry about selecting the wrong fastener for different slot thicknesses or for a different fastening point in the body panel or headliner.

The fastener clip may also continuously adapt to changes in environmental conditions such as vehicle flexing, vibration and thermal expansion. For example, the fastener clip may adapt to changes in thermal expansion, especially due to the differences in thermal expansion rates between dissimilar metals or metal to plastic with respect to the vehicle chassis components and/or between plastic components such as the interior trim panels attached to the metal vehicle chassis. The fastener clip may also fasten to plastic and/or metal engagement structures. The fastener clip dampens vibrations and thus eliminates or substantially reduces buzz, squeak and rattles. The fastener clip and carrier may be made of anti-corrosive material such as plastic or treated metal to provide long reliable service life.

Yet another advantage is that the fastener clip is relatively easy to manufacture using relatively inexpensive manufacturing processes and materials. The use of the fastener clip decreases production costs, increases worker productivity and efficiency and decreases overall vehicle assembly costs. The fastener clip securely attaches any suitable body panel to the vehicle chassis, such that the fastener clip improves reliability both in the short term and in the long term, while further improving vehicle safety and quality.

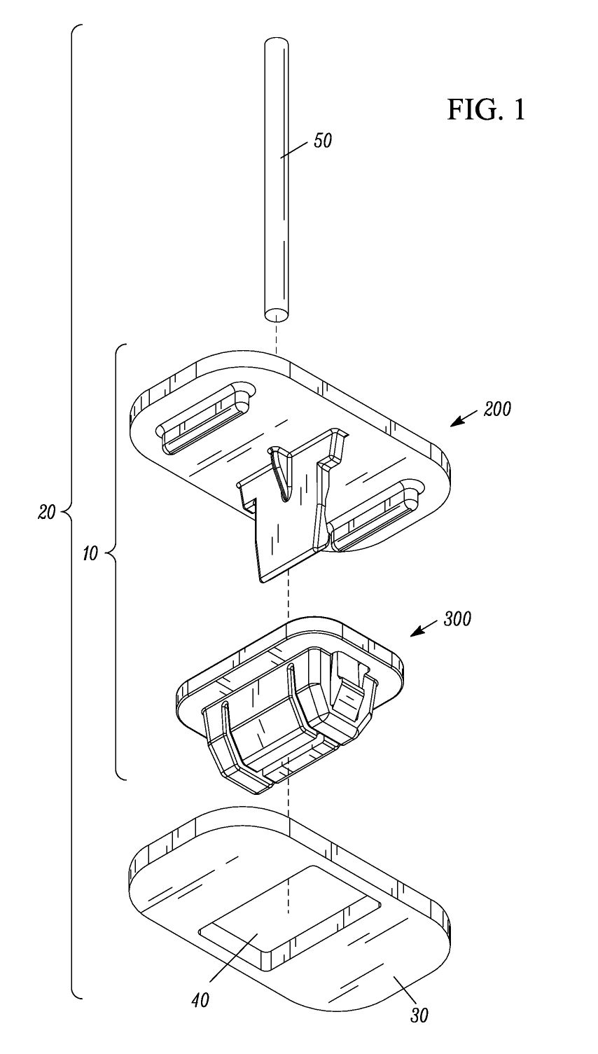

FIG. 1 is an exploded view of a fastener clip 10 and assembly 20 according to one embodiment. The fastener clip 10 is operable to be inserted into a chassis 30 having a slot 40. The fastener clip 10 is removable, so a service tool 50 may be inserted into the fastener clip 10 to remove the fastener clip 10 from the chassis slot 40 as described in detail below.

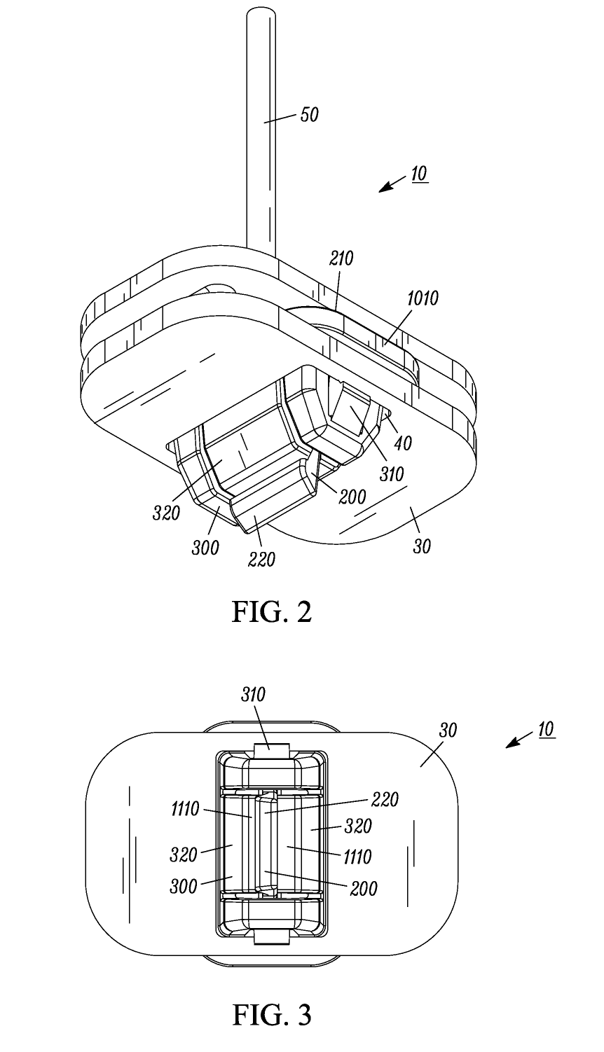

FIG. 2 is a perspective view of a fastener clip 10 and assembly according to one embodiment. The fastener clip 10 comprises a prong clip 200 that is operable to engage a carrier 300. The prong clip 200 has a prong base 210 on one end and a prong 620 with a hook 220 at the other end of the prong clip 200. The carrier 300 comprises a pair of laterally offset side wings 310 extending from the carrier 300 operable to fasten to the slot 40, such as a structure 30 like a vehicle chassis. A pair of laterally offset arms 320 extend from the carrier 300 create a gap 330 to form a hook receiver.

The hook receiver 330 is operable to engage the hook 220 such that a service tool 50 may operably disengage the hook 220 from the hook receiver 330 on a side of the slot 40 that is opposite the prong base 210. For example, the hook receiver 330 engages the hook 220 after the hook 220 passes through the slot 40. Therefore, the prong base 210 and the carrier base 1010 are on an inside of the slot 40, and the hook receiver 330 and hook 220 are on an outside of the slot 40 when the fastener clip 10 is inserted into the slot 40. Hook(s) 220 and the hook receiver 330 may be optionally mounted or attached from the inside of the slot 40, above chassis 30.

The service tool allows the prong clip 200 and carrier 300 to be easily engaged and disengaged. Further, a service tool, similar or different from tool 50 may be inserted to release the arms 320 from engaging the slot 40, thus disengaging the carrier 300 from the chassis 30.

Although the fastener clip 10 is shown with two arms 320 and two wings 310, any suitable number of arms 320 and wings 310 may be used. For example, two arms 320, three arms 320, four arms 320 and one, two, three or four and so forth wings 310 may be used, or any suitable number may be used. The arms 320 and the wings 310 may have any suitable shape, such as for example: tapered, straight, curved or any suitable shape.

FIG. 3 is a top view of the fastener clip 10 and assembly 20 according to another embodiment. According to one embodiment, the hook 220 and the wings 310 are in orthogonal planes. As shown, the hook 220 engages the arms 320 on a wide side of the carrier 300 and prong clip 200, while the wing 310 engages a narrow side of the carrier 300 and prong clip 200, where the wide and narrow sides are perpendicular.

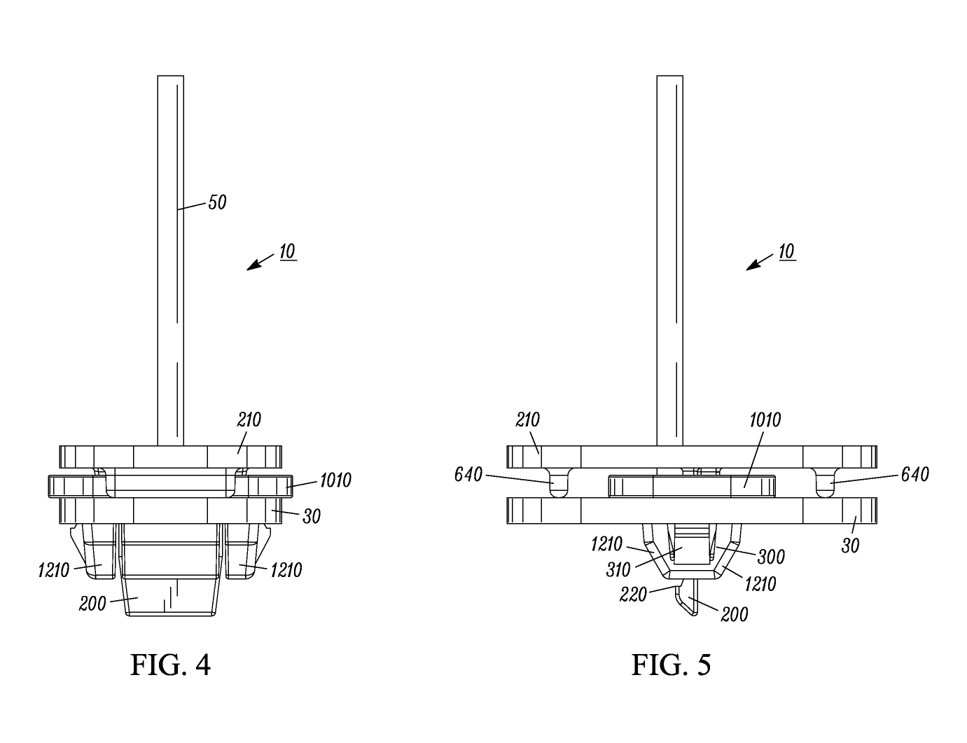

FIG. 4 is a side view of the fastener clip and assembly 10 according to another embodiment. According to one embodiment, arms 320 are joined with hook 220 at a distant portion away and opposite from the prong base plate 210 when the clip 10 is inserted in the slot 40, as shown in FIG. 2. The joined arms 320 and hook 220 are tapered and thus may provide a guide for inserting the fastener clip 10 into the slot 40 of the structure 30, such as a roof, during assembly.

FIG. 5 is a side view of the fastener clip 10 and assembly 20 according to another embodiment rotated 90 degrees. According to one embodiment, the fastener clip 10 further includes side wings 310 to engage the slot 40. The side wing 320 engage a narrow edge of the slot 40 and optional engagement regions on the first and second wings 320 engage a relatively wide edge of the slot 40.

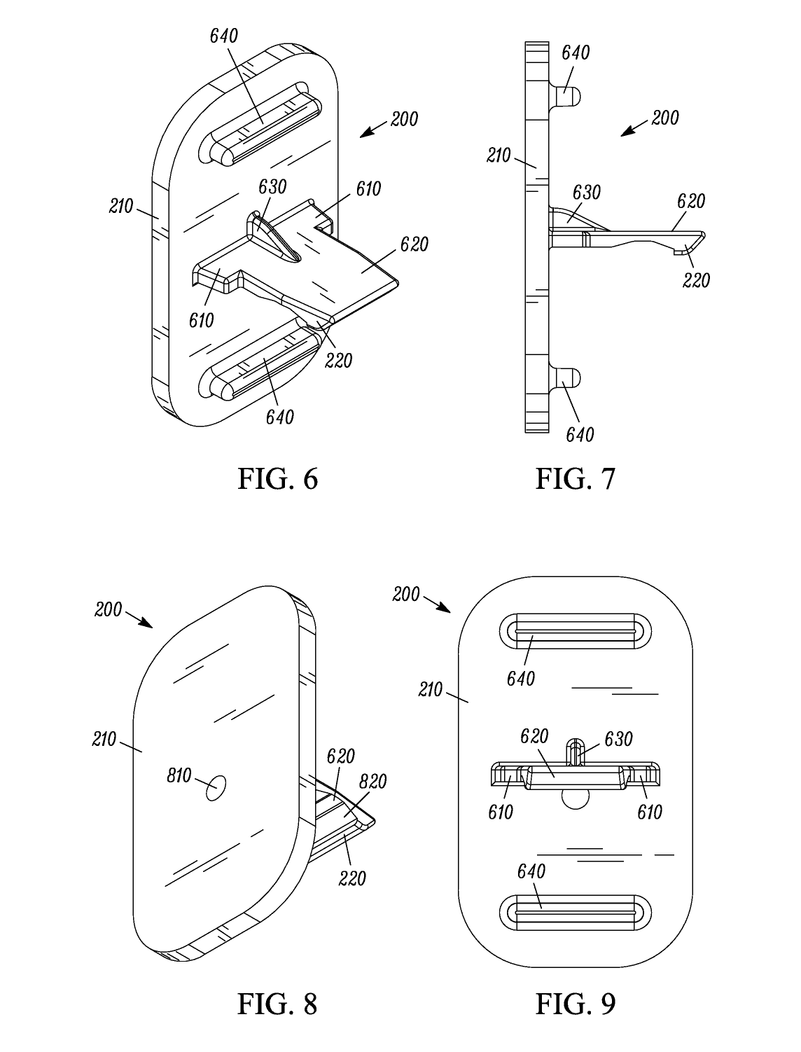

FIG. 6 is a top perspective view of the prong clip 200 according to one embodiment. As shown in FIG. 6, the prong clip 200 further includes a prong 620 and at least one flare 610 operative to impede the wings 310 from flexing in. According to one embodiment, flares 610 are on the base of prong 620 at ends opposed the prong 620. For example, the wings 310 either touch or are close together with flares 610 to prevent or reduce movement between the wings 310 from flexing in or collapsing and disengaging the slot 40. Thus, flares 610 strengthen the fastener clip 10 to improve engagement and prevent separation from the slot 40.

FIG. 7 is a side view of the prong clip shown in FIG. 6. The hook 220 may have any suitable shape to engage arms 310. According to one embodiment, the hook 220 comprises a ledge 820 to engage the hook receiver 330. As shown, the ledge 820 has a surface that is inclined, stepped and then parallel to finger 1110 on arm 320. For example the hook 220 shape may be: a ledge, a protrusion, prong, edge, rounded, bulbous, stepped, angled, dimple, and depression.

According to one embodiment, the prong base 210 further comprises at least one stand-off 640. The stand-off 640 provides sufficient spacing and support between prong base 210 and carrier base 1010.

FIG. 8 is a bottom perspective view of the prong clip 200 according to one embodiment. The prong base 210 further comprises a tool hole 810 to allow entry of the service tool 50. For example, the service tool 50 may be a rod, prong, pin or screw driver or any suitable shape or device. Accordingly, the shape of tool hole 810 would correspond to the shape of the service tool 50.

FIG. 9 is a top view of the prong clip. According to one embodiment, prong 620 is strengthened by flange 630 by providing additional rigidity to enhance insertion of the hook 220 into hook receiver 330. Also, flange 630 further strengthens prong 620 to enhance retention strength and to reduce sway in prong 620. The tool hole 810 is positioned so that as the service tool 50 is inserted and engages ledge 820, service tool 50 pushes prong 620 causing prong 620 to flex away from fingers 110 to facilitate disengagement of prong clip 200 from carrier 300.

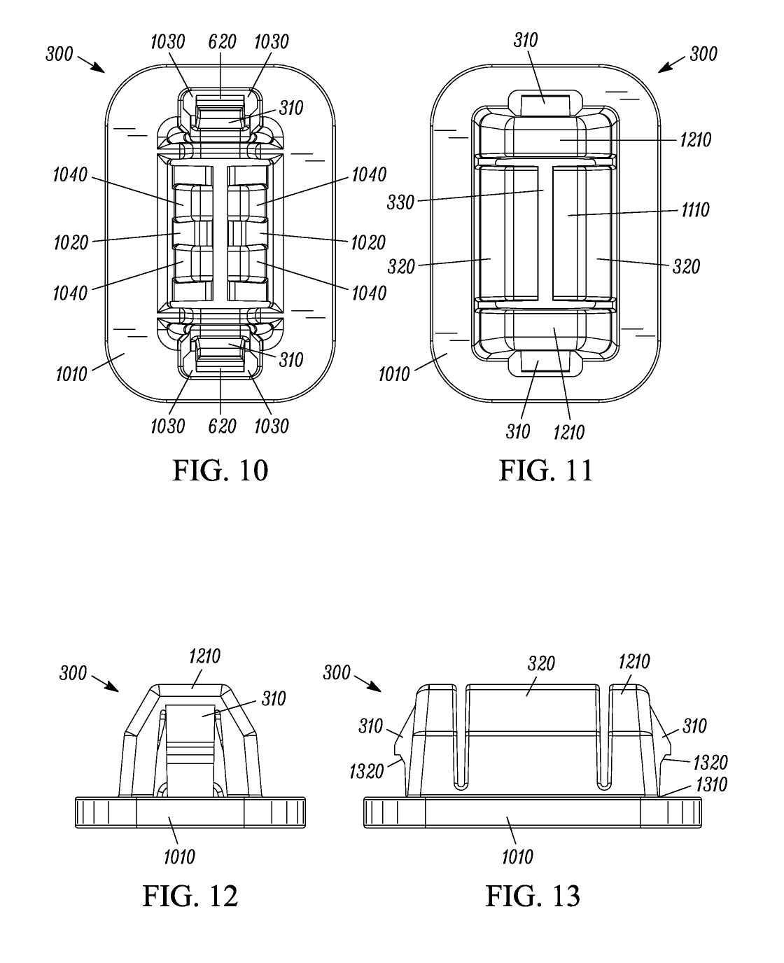

FIG. 10 is a bottom view of a carrier 300 according to one embodiment. According to one embodiment, the arm 320 interior includes a channel 1020 having at least one of: an abrupt angled roof; a gradual angled roof; a curved roof; a discrete multi-angled roof; and a pointed roof, relative to the prong to guide the service tool to disengage the hook 220 from the hook receiver 330. Optionally, rib(s) 1040 separate channels 1020 to further define channels 1020 and form a path to guide the service tool 50 to disengage the hook 220 from the hook receiver 330. According to one embodiment, the carrier 300 includes an access tab 1030 formed in the carrier 300 adjacent at least one wing 310. The access tab 1030 allows a service tool 50 such as a screw driver to flex the wings 310 back in to allow removal of the carrier 300 from the slot 40.

FIG. 11 is a top view of the carrier 300 according to one embodiment. As shown, the each arm 320 further comprises a finger 330 extending from the arms 320 to form a complimentary hook receiver and operable to engage the hook 220.

FIG. 12 is a side view of the carrier 300. The shoulders 1210 are substantially in a same plane as the pair of laterally offset arms 320 but do not have a gap. The shoulders 1210 may have any suitable shape depending on insertion requirements and space considerations. For example, shoulders 1210 may be have any shape suitable to guide insertion of the carrier 1020 into the corresponding slot 40 in the roof and to aid installation, provide suitable placement, alignment, structural strength and rigidity. Additionally, alignment is maintained during disassembly and reassembly at any of the phases of operation.

FIG. 13 is a side view of the carrier as shown in FIG. 12 rotated 90 degrees in accordance with an exemplary embodiment. As shown, shoulders 1210 extend from the carrier base 1010 on opposite side of arms 320. According to one embodiment, at least one of the wings 310 and the hook 220 further includes an engagement region 1320. The engagement region 1320 may have any shape such as at least one of: a ledge, a protrusion, prong, edge, rounded, bulbous, stepped, angled, dimple, and depression.

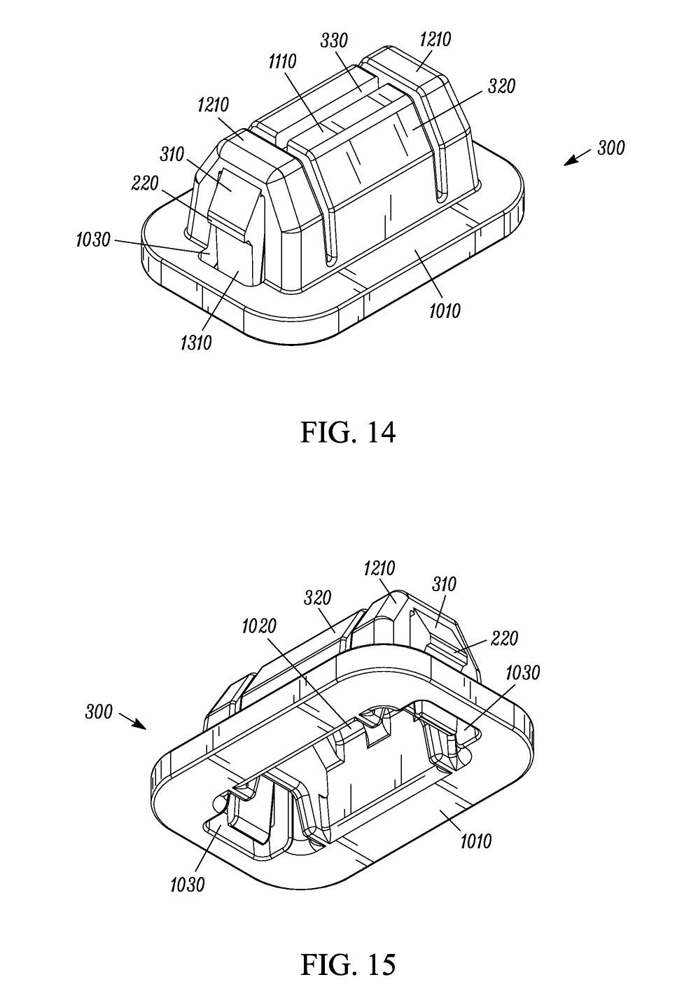

FIG. 14 is a top perspective view of the carrier 300 according to one embodiment. As shown in FIGS. 13 and 14, the wings 310 have a size, such as a width, length, thickness and a pivot point 1310 to provide very high extraction force levels while the insertion force level is relatively very low. For example, the pivot point 1310 may be weakened by scoring, stamping, bending or cutting, or any suitable means on wing 310 to ensure that the wings 310 spring inward as required so that the insertion force is low relative to the extraction force. Since the wings 310 are in compression during extraction, the weakened pivot point 1310 does not significantly weaken the extraction force yet the insertion force is reduced. Additionally, the width of the wing 310 may be increased to further increase the strength of the wing 310 and thus increase the extraction force, as well as increase the size of the engagement region while keeping the insertion force relatively low. Alternatively, the width of the wing 310 may be decreased, or the wings 310 may have different widths and engagement regions 1320 to achieve any desired insertion force, extraction force or suitable ratio. According to one embodiment, the engagement force is less than an extraction force.

FIG. 15 is a bottom perspective view of a carrier 300 according to one embodiment. According to one embodiment, the engagement region 1320 includes an angled or depressed portion formed on each wing 310, such that each angled or depressed portion is operative to engage at least a portion of the slot 40 defined in the chassis 30 and is operable to adapt to variations or movement of slot 40. For example, the angled or depressed portion may be formed as part of a mold or manufactured by stamping a step or ridge on wings 310 to form the depressed portion. The size, dimensions and shape of the angle or depressed portion may be formed in any suitable manner in order to permit relatively easy insertion of the fastener clip 200 into the chassis 30 while increasing the extraction force.

To facilitate engagement, the hook 220 or finger 1110 may include, for example, an abrupt edge, a gradual angled edge such as a curve, a single angled edge, a discrete multi-angled edge and a pointed edge or any suitable edge. For example, these shapes may be stamped, cut, molded, etched (i.e. chemical, laser, or knife etching for example) or formed in any suitable manner such that a protrusion, prong, edge, rounded, bulbous, stepped, angled, and depressed or other suitable shape is formed for example in a non-planar orientation relative to an end of the wings 310. These shapes are formed on the hook 220 so as to engage or “catch” slot 40 to increase an extraction force for the fastener clip 10 when removed from the slot 40.

During insertion, the engagement force between fastener clip 10 and first chassis 30 may be, less than the extraction force. Any other suitable amount or range of insertion and extraction force for an appropriate application is contemplated. For example, the amount of insertion and extraction force for any application, large or small would require corresponding appropriate sized and characteristics of the hook 220 or finger 1110 described herein. The hook 220 or finger 1110 may further include characteristics such as an edge formed to include either a single curvature or multiple curvatures to engage the slot 40 rim. The amount of curvature, the depth of the depression, the width of the depression and the number of depressions may be sized in order to provide the desired level of extraction force due to the frictional engagement between any portion of the hook 220 or finger 1110 and the slot 40.

According to another embodiment, the fastener clip 10 is made of: plastic, acetal, polyacetal, polyoxymethylene, nylon, fiberglass, Acrylonitrile butadiene styrene (ABS), and/or carbon fiber, however any suitable material may be used in any combination such as steel, tin and/or any suitable metal. For example, the carrier 300 and prong 200 (or body panel) may be formed via injection molding either with or without action. According to an alternative embodiment, a coating is applied on the fastener clip made of at least one of: nickel plating, zinc plating, rubber, plastisol, plastic, acetal, polyacetal, polyoxymethylene, nylon, fiberglass and/or carbon fiber to suitably provide corrosion resistance and to reduce rattling.

According to one embodiment, the prong 200 may be formed or attached to a body panel. The prong 200 may be a base part of a body panel or a structure to support the prong 20 that can be glued, screwed, snapped, fastened or attached to a body panel. The body panel, such as a roof rack, bracket or headliner, may be constructed from plastic or from any suitable material such as steel, aluminum, magnesium, wood, plastic, fiber glass, carbon fiber or any suitable material. According an alternative embodiment, the fastener clip 10 is made of: steel, tin aluminum, magnesium, copper, carbon fiber or any suitable metal or alloy.

According to one embodiment the carrier 300 and prong 200 are suitable to retain the fastener 10 in the chassis 30, by for example sliding the fastener 10 until it clicks or snaps in. Engagement may be accomplished using any suitable structure. For example, the wings 310 or hook 220 may have a protrusion that forms the edge. The protrusion according to one embodiment may comprise a taper and may take any suitable shape, such a linear incline of a suitable angle, or any suitable curve. The hook 220 frictionally engages and latches or holds the arm 320 of the fastener clip 10. Hook(s) 220 may be shaped as a point, corner, dome, with any suitable curvature or angle to suitably latch fastener 10. The protrusion forming the wings 310 or hook 220 is flexible enough to bend sufficiently so as to allow the wings 310 or hook 220 to clear, or lift above corresponding engagement surface and thus allow the fastener clip 10 to be attached and removed. However, after the fastener clip 10 is inserted and snapped in, the wings 310 or hook 220 are not flexed, rather, the shoulders 610 and flange 630 impede or prevent the wings 310 or hook 220 from slipping out although a compressive force may occur due to removal of the fastener clip.

Alternatively, shoulders 610 and flange 630 may have an alternative shape, such as a coiled wire spring, a lever spring, a curved wire or leaf spring, or any spring and any material (metal, plastic, etc.) suitable to impede removal wings 310 or hook 220.

It is understood that the implementation of other variations and modifications of the present invention in its various aspects will be apparent to those of ordinary skill in the art and that the invention is not limited by the specific embodiments described. It is therefore contemplated to cover by the present invention any and all modifications, variations or equivalents that fall within the spirit and scope of the basic underlying principles disclosed and claimed herein.

What is claimed is:

1. A fastener clip comprising:
a prong clip having a prong base on one end and a hook at the other end of the prong clip;
a carrier comprising:
a pair of laterally offset side wings extending from the carrier operable to fasten to a slot; and
a pair of laterally offset arms extending from the carrier forming a hook receiver and operable to engage the hook such that a service tool may operably disengage the hook from the hook receiver on a side of the slot that is opposite the prong base.

2. The fastener clip of claim 1, wherein the arm includes a channel having at least one of: an abrupt angled roof; a gradual angled roof; a curved roof; a discrete multi-angled roof; and a pointed roof, relative to the prong to guide the service tool to disengage the hook from the hook receiver.

3. The fastener clip of claim 1, wherein the carrier includes an access tab formed in the carrier adjacent at least one wing.

4. The fastener clip of claim 1, wherein at least one of: the wings and the hook, further includes at least one of: a ledge, a protrusion, prong, edge, rounded, bulbous, stepped, angled, dimple, and depression.

5. The fastener clip of claim 1, wherein the prong further includes at least one flare operative to impede the wing from flexing in.

6. The fastener clip of claim 1, wherein the hook and the wings are in orthogonal planes.

7. The fastener clip of claim 1 further comprising a finger extending from each arm to form the hook receiver and operable to engage the hook.

8. The fastener clip of claim 1, wherein the service tool is a rod, prong, pin or screw driver.

9. The fastener clip of claim 1, wherein an engagement force is less than an extraction force.

10. The fastener clip of claim 1, wherein at least one of: the prong clip or carrier is made of at least one of: rubber, plastisol, plastic, acetal, polyacetal, polyoxymethylene, nylon, fiberglass and carbon fiber.

11. The fastener clip of claim 1, wherein at least one of: the arms, prong, hook and wing, is tapered, straight or curved.

12. The fastener clip of claim 1, wherein: the prong base further comprises at least one stand-off.

13. A fastener assembly comprising:
a body panel comprising a prong clip having a prong base on the body panel and a hook at the other end of the prong clip;
a carrier comprising:
a pair of laterally offset side wings extending from the carrier operable to fasten to a slot; and
a pair of laterally offset arms extending from the carrier forming a hook receiver and operable to engage the hook such that a service tool may operably disengage the hook from the hook receiver on a side of the slot that is opposite the prong base.

14. The fastener assembly of claim 13, wherein the arm includes a channel having at least one of: an abrupt angled roof; a gradual angled roof; a curved roof; a discrete multi-angled roof; and a pointed roof, relative to the prong to guide the service tool to disengage the hook from the hook receiver.

15. The fastener assembly of claim 13, wherein the carrier includes an access tab formed in the carrier adjacent at least one wing.

16. The fastener assembly of claim 13 wherein at least one of the wings and the hook further includes at least one of: a ledge, a protrusion, prong, edge, rounded, bulbous, stepped, angled, dimple, and depression.

17. The fastener assembly of claim 13, wherein the prong further includes at least one flare operative to impede the wing from flexing.

18. The fastener assembly of claim 13, wherein the hook and the wings are in orthogonal planes.

19. The fastener assembly of claim 13, further comprising at least one removal tab at and end of at least one wing.

20. A vehicle comprising:
a vehicle chassis having a slot;
a body panel comprising a prong clip having a prong base on the body panel and a hook at the other end of the prong clip;
a carrier comprising:
a pair of laterally offset side wings extending from the carrier operable to fasten to a slot; and
a pair of laterally offset arms extending from the carrier forming a hook receiver and operable to engage the hook such that a service tool is operable to disengage the hook from the hook receiver on a side of the slot that is opposite the prong base.

21. The vehicle of claim 20, wherein the carrier includes an access tab formed in the carrier adjacent at least one wing.
